(19) United States
(12) Patent Application Publication
(10) Pub. No.: US 2024/0404389 A1
(43) Pub. Date: Dec. 5, 2024

(54) Differential Pressure Short Stroking Detector System

(71) Applicants: Curtis Alan Roys, Fredericksburg, TX (US); Charles Emmitt Hughes, Odessa, TX (US)

(72) Inventors: Curtis Alan Roys, Fredericksburg, TX (US); Charles Emmitt Hughes, Odessa, TX (US)

(21) Appl. No.: 18/656,579

(22) Filed: May 6, 2024

Related U.S. Application Data
(60) Provisional application No. 63/500,571, filed on May 5, 2023.

(51) Int. Cl. G08B 21/18; G01F 13/00

(52) U.S. Cl. CPC G08B 21/182; G01F 13/006

(57) ABSTRACT

A system detects Differential Pressure Short Stroking by comparing the expected lubricant flow with the actual lubricant flow as determined by either manual timing stokes of a flow analyzer or automatically receiving signals corresponding to strokes of the analyzer and calculating the flow.

### TECHNICAL FIELD OF THE INVENTION

The present invention relates to lubrication systems for natural gas compressors.

### BACKGROUND AND SUMMARY OF THE INVENTION

Divider block systems provide lubricant at a relatively high pressure and low volume. Compressor divider block systems inject oil into a fairly wide range of pressures because cylinder injection points, packing injection points, suction flushing injection points, etc., all need to be lubricated correctly and it takes different pressures to force oil into the points needing lubrication. The divider block lubrication systems almost never work against the same equal pressure when injecting oil into the compressor cylinders, rods or packing glands. For example, FIG. 9 shows the pressures at different injection points of a compressor system and the percentage deviation for the average pressure.

FIGS. 8A-8C show the pressure and temperature at three different injection points on a different system. Note that the pressure at Throw 1 Cyl top (1072 psi) and the pressure at Throw 1 Cyl bottom (1055 psi) are similar, but the pressure at throw 1 packing (85 psi) is only 85 psi. The significant difference in pressure results in difference in fluid flow.

For several decades, divider block manufacturers have recommended that all injection points of the divider block lubrication system should be equalized if the system is operating above 1000 psi. This was to ensure the divider block system would operate fluidly and the compressor rings, rods, packing and cylinders would receive the correct amount of oil. Balancing the divider block system would not only allow the system to operate reliably but would also increase the longevity of the divider block system components. Although many OEM's and system designers have not adhered to the divider block manufacturers recommendation for today's lube system designs, there are several companies that will follow the divider block OEM's recommendation to include the installation of balancing valves on systems that operate above 1500 psi.

By research and measuring the actual output of divider valves, applicant has found that divider block systems that supply the oil to the compressor rings, rods, packing and cylinders under different pressures are extremely compromised and do not supply the correct quantity of oil as specified by the manufacturer. This is due in part to the pistons in the lubrication system short stroking, which reduces the oil output volume. This new discovery is termed D.P.S.S. (Differential Pressure Short Stroking). The short stroking of the divider block pistons is caused by the system operating at pressures with over 200 psi differential, and they do not supply the correct quantity of oil to any of the highest and mid pressure lubrication points. The lack of correct lubrication caused by D.P.S.S. creates premature wear and failure of rings, rods, cylinders and packing glands.

Throughout the years, purchasers of compressor divider block systems have assumed the stated quantity of oil dispensed by different piston sizes was evaluated by the OEM compressor manufacturers, and those output quantities were accurate. Our field test on the lubrication system (on actual operating compressors,) and lab tests performed in a controlled environment, have proven all manufacturers divider block lubricant output values are affected by several factors or a combination thereof:
Differential pressures the pistons in the block assembly are working against;
Placement or positioning of each divider block on the base section of the assembly, top to bottom; and
Elevated discharge pressures the divider block assembly is working against.

Applicant has found how each of these factors play a significant role in influencing the travel of the piston in the divider block, how the oil output values of individual divider blocks are affected, and how the lubricant output value of each divider block is directly related to the positions each divider block is mounted on the base section, from top to bottom.

The findings (both in field testing and laboratory) have proven that compressor divider block lubrication systems are generally not supplying the rings, rods, packing and cylinders with the correct quantity of oil as designed, which in turn has been causing premature wear and failure of compressor components for decades. Unfortunately, premature wear and failure through the years has been accepted as “Normal Components Wear and Failure!”

Through the years, compressor owner/operators have come to accept premature wear or failure of components as “what is to be expected after specific run time hours.” After discovering the phenomenon of D.P.S.S., what was previously considered normal wear and failure of the compressor components is no longer to be considered normal: it is abnormal.

With the discovery of D.P.S.S. taking place in the divider block system, many instances of premature wear and failure of compressor cylinders, rings, packing and rods can now be attributed to the reduced oil output of the divider block system when operating in differential pressure ranges above 200 psi. The lack of proper lubrication of compressor components causing premature wear and failure of compressor components can now be prevented or greatly reduced! It was not previously recognized that balancing output pressures of a divider block is necessary at low pressures, such as below 1,500 psi, below 1,000 psi, below 800 psi, below 500 psi and as low as 200 psi. By “balancing a divider block” is meant that the pressure into which the lubricant is ejected at the output of the divider block is similar for each of the outlets of the divider block. By “similar” is meant that the pressure at each outlet is within 10%, within 5%, within 2% or within 1% of the pressure at every other outlet.

The discovery of D.P.S.S. and field testing and verification revealed a high percentage of premature wear or failure of wear components is attributed to divider block piston short-stroking, which results in reduced oil output. D.P.S.S. phenomenon is created when divider blocks are operating in differential pressure ranges between each divider block piston. D.P.S.S. results when each divider block piston is operating into pressures that have not been equalized within about 200 psi in some cases.

After the discovery of D.P.S.S., Applicant needed an efficient method to measure and document shop and field testing results. Prior to the development of the D.P.S.S. Detector, the process of measuring and scoring the output of a divider block was a tedious, complex and time-consuming task. The development of this device enables any user to measure and score the output performance of a divider block quickly and easily. Having a user-friendly and efficient way to determine if divider blocks are performing as designed and are properly lubricating allows compressor owners and operators to know, in a matter of minutes, if their components are at risk for premature wear and damage.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows schematically a system for monitoring a lubrication system for a natural gas compressor;

FIG. 2 shows a system similar to FIG. 1, but using wireless communication, such as Bluetooth, to communicate between the components;

FIG. 3A-3D shows a fluid flow analyzer comprising a three cylinder, single input and single output divider block, with FIG. 3A showing an end view, FIG. 3B showing the interior of a dispensing valve; FIGS. 3C and 3D showing cross sections with the dispensing valve rotated so that the lower piston is facing the user, with FIG. 3C including an attached fluid flow sensor and FIG. 3D showing an attached fluid flow monitor;

FIG. 4 describes a proximity switch that can be used in the systems of FIGS. 1 and 2;

FIG. 5 shows the hardware of a D.P.S.S. Detector;

FIG. 6 is a flowchart showing steps for detecting D.P.S.S.;

FIG. 7 is a flowchart showing steps for detecting D.P.S.S.;

FIGS. 8A-8C show pressures at three different injection points in a prior art system in which the pressure outputs are not equalized;

FIG. 9 shows pressures measured at different injections points of a prior art natural gas compressor, and the percentage of average pressure at each injection point;

FIG. 10 shows the display of a D.P.S.S. Detector showing an ‘at-risk’ scenario;

FIG. 11 shows a startup screen after power is applied to the DPSS;

FIG. 12 shows a setting screen that prompts the user to set the block value of the divider block supplying the injection point being analyzed;

FIG. 13 shows the screen displayed after a manual cycle time is entered;

FIG. 14 shows the screen after an automatic cycle time is entered;

FIG. 15 shows a screen display indicating that the system is awaiting a pulse;

FIG. 16 shows a screen display showing a snapshot of the changing results as the system is analyzing through pulses;

FIG. 17 shows a screen display showing analysis results across several pulses showing an underperforming block; and

FIG. 18 shows the screen of the D.P.S.S. Detector when the lubrication system is producing acceptable results.

### DETAILED DESCRIPTION OF PREFERRED EMBODIMENTS

The term “D.P.S.S. Detector” refers to a device that receives input and/or signals for a user and/or a lubrication system and determines and indicates whether or not the lubrication system is injecting a pre-determined amount of lubricant. The term “analyzer” or “analyzer block” refers to a device that measure actual fluid flow, such as a single input/single output, 3 piston, divider block, and is typically positioned in-line with the injection point to determine the amount of lubricant injected. The term “proximity switch” refers to a device that is used in conjunction with divider block, including the analyzer, to indicate cycles of a piston in a divider block. A “ProFlow” device is a device connected to a divider block that counts and displays cycles from a proximity switch.

The D.P.S.S. Detector works in conjunction with an analyzer block and a proximity switch, such as the Patton Bullet proximity switch, coupled with a pressure transducer, such as the Patton Scout Bluetooth pressure transducer. The combined devices provide precise measurements of the oil being injected into a specific injection point and the pressure required to inject into that injection point. Using the Bluetooth app, the injection pressure can be viewed and logged. Using the D.P.S.S. Detector, the precise amount of oil being injected is presented, along with a comparison to the amount of oil that should be reaching that injection point. A scoring of that comparison is presented by a performance percentage and a corresponding illuminated LED within a ‘high/optimal/low’ LED array. While the description below often refers to a single analyzer and proximity sensor connected to a single input/single output, 3 piston, divider block, a typical lubrication system includes multiple injection points, which an analyzer and proximity sensor at each of the injection points.

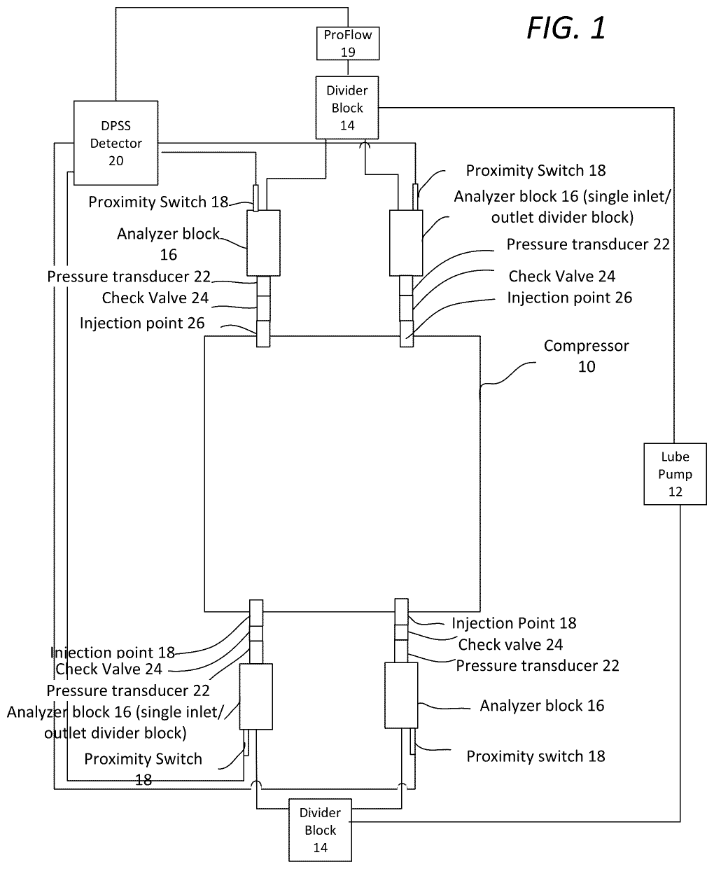

FIG. 1 shows the hardware components of a system for detecting D.P.S.S. The system provides lubricant to compressor 10. The lubrication system includes lube pump 10 that supplies lubricant to two divider blocks 14. Each divider block 14 supplies lubricant to multiple analyzer blocks 16. A proximity switch 18 is attached to each analyzer block 16, and the electrical output from each proximity switch 18 is electrically connected to a ProFlow 19 and to a DPSS Detector 20. In some embodiments, some of the functions of the ProFlow 19 can be incorporated into the D.P.S.S. Detector 20. At the output of each analyzer block 16 is a pressure transducer 22 measuring the output pressure at the analyzer block and a check valve 24 prior to an injection point 26 on the compressor. Skilled persons will recognize that there may be many more lubrication injection points on the compressor, each receiving lubricant from a divider block 14 through an analyzer block, pressure transducer, and check valve.

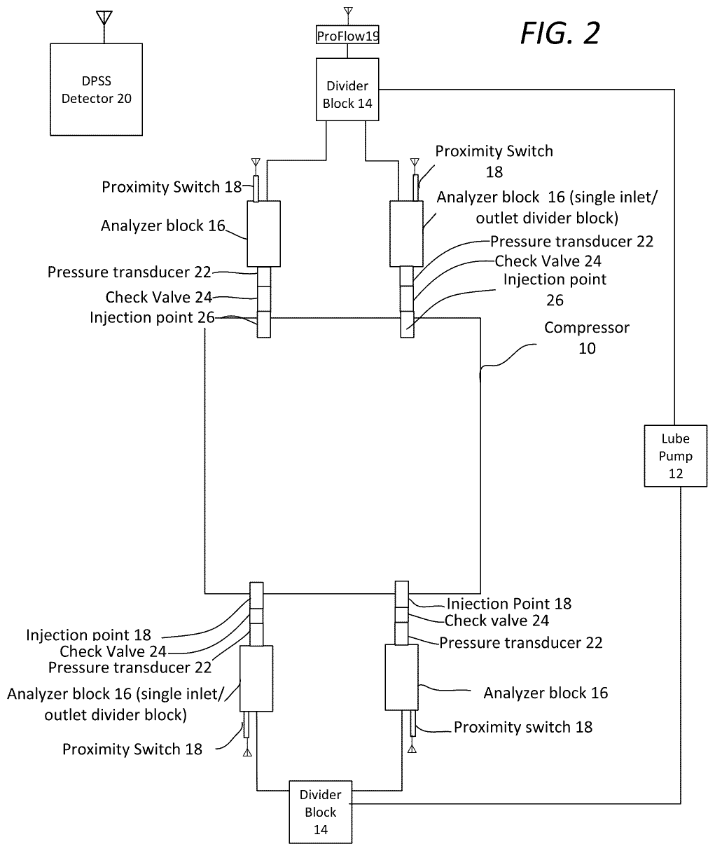

FIG. 2 shows the hardware components of a system for detecting D.P.S.S similar to that of FIG. 1, but in which the components communicate wirelessly. Each proximity switch 18 includes a wireless transmitter, the pressure transducers 22 optionally include a wireless transmitter, a ProFlow 19 includes a wireless receiver for receiving pulse signals from the proximity switches and a wireless transmitter for transmitting data to the D.P.S.S. Detector, which includes a receiver for receiving data from the ProFlow and optionally from the pressure transducers. This system is placed inline and can be connected while the compressor is running and loaded. It is connected at the injection point, to the input end of the injection check valve, or can be connected to an upstream bulkhead union. Once installed, oil will pass through the Analyzer block and results in pulsing from the Bullet proximity switch, which is logged by the D.P.S.S. Detector. As cycle times of the Analyzer are logged, the D.P.S.S. Detector averages them, then compares the actual oil flow to the expected flow from the divider block that lubricates that injection point. The onscreen scoring indicates whether that divider block is performing as designed or possibly short-stroking and delivering less oil than expected and assumed. If the divider block is not preforming as designed, the outputs can be adjusted as described in U.S. patent application Ser. No. 18/298,347 until the output are balanced and the divider block is preforming as designed.

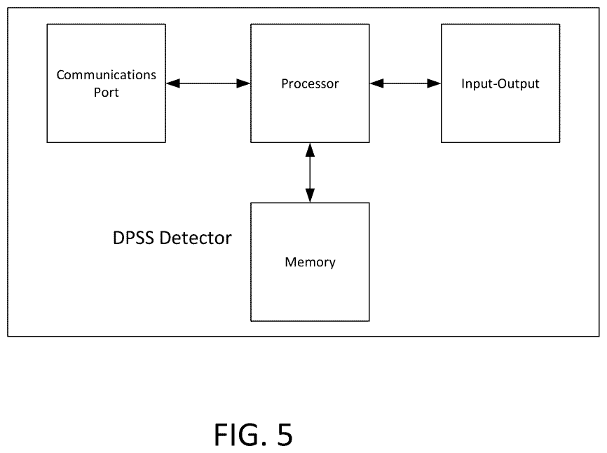

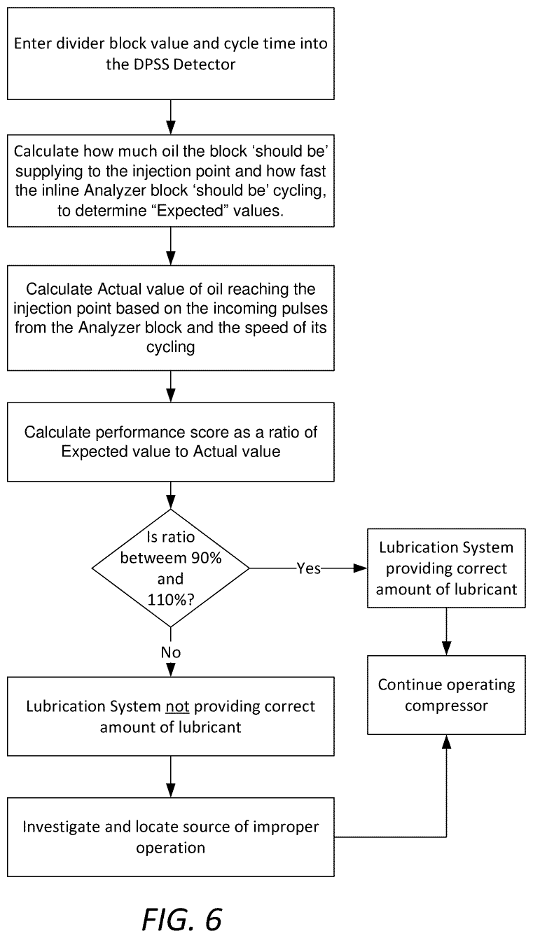

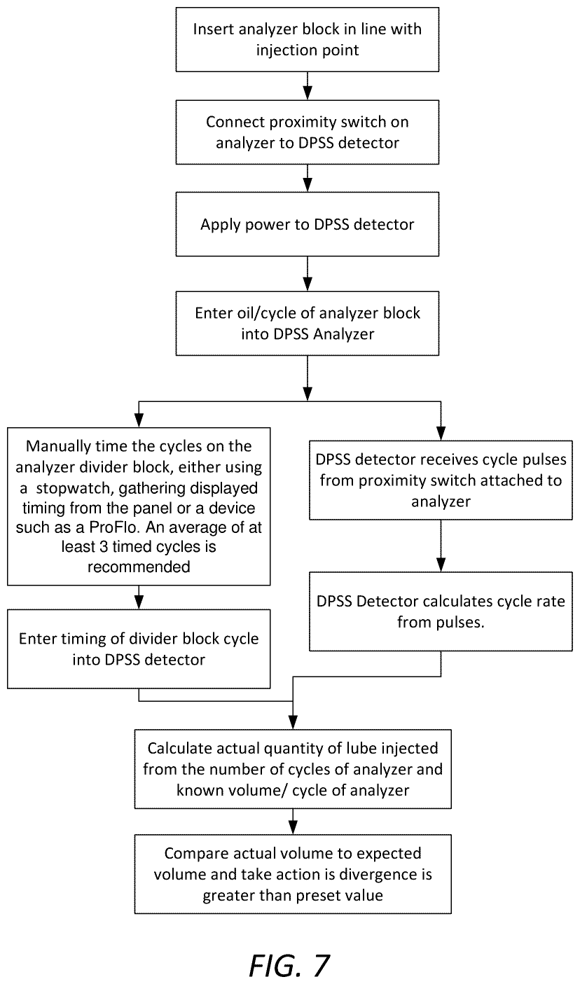

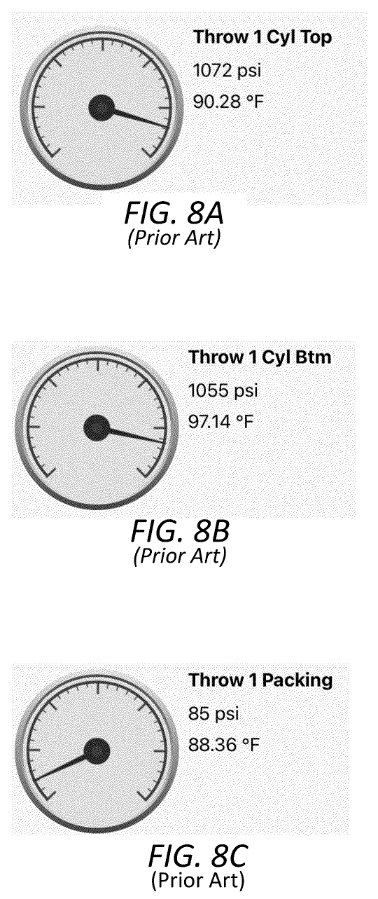

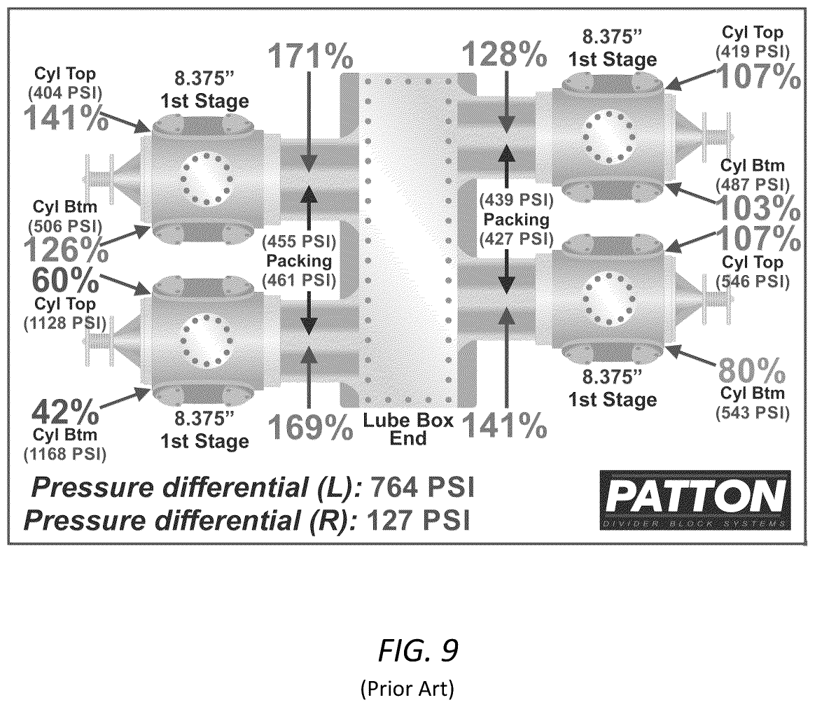

FIG. 5 shows that the D.P.S.S. Detector includes a processor, a memory for storing data and program commands, and an input/out means, which may be for example, a touch screen, a keyboard and display, or alternatively the D.P.S.S. Detector can use a wireless device, such as a cell phone or tablet, for input and display. The D.P.S.S. Detector has the capability of receiving signals from external devices, such as pulses from one or more proximity sensors connected to the single input/single output divider block analyzer and/or pressure transducers. The processor has the ability to count pulses from the proximity sensors and calculate the quantity of lubricant being injected at an injection point on a compressor. A compressor will typically have multiple cylinders with lubricant injection points at the cylinders and at packings.

When used in automatic mode, in conjunction with an additional proximity switch temporarily installed on the divider block assembly, everything is automatic, aside from the entry of the divider block value. This removes almost all potential human error and highly accurate results are available in a matter of minutes.

### Measurement & Scoring

As oil flows through the 3-piston hydraulic circuit of the Analyzer block, the speed of its cycling is directly affected by how much oil is forced through it. As more oil is forced through, it cycles faster, and less oil results in slower cycle times. The cycle time of the Analyzer indicates exactly how much oil is entering the Analyzer block and reaching the downstream injection point.

A divider block's oil output is normally determined by its face value and how fast the assembly on which it is installed is cycling. The faster the assembly is cycling, the more oil it outputs, and slower cycle times result in less oil output reaching the injection point.

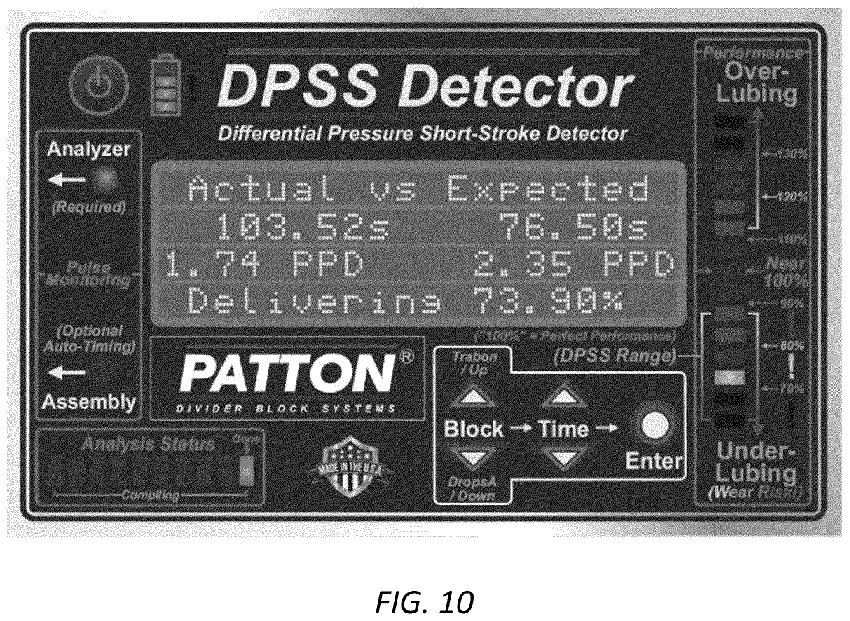

With the divider block value and cycle time entered into the D.P.S.S. Detector, it automatically calculates how much oil the block ‘should be’ supplying to the injection point and how fast the inline Analyzer block ‘should be’ cycling, with both values presented as “Expected”. The incoming pulses from the Analyzer block allow the D.P.S.S. Detector to calculate how much oil is passing through the Analyzer block and reaching the injection point, based on the speed of its cycling. The D.P.S.S. Detector can then compare the “Actual” to the “Expected” and present a performance score, both on the display screen and within the LED array. A performance score of 100% would indicate perfect performance of the divider block being analyzed. This would be coupled with an illumination of the green LED in the center of the performance array. An underperforming block would result in a score below 100% and illumination of one of the lower performance LEDs, once the “Delivering” score drops below 90%. A score within 90-110% is considered the ‘optimal’ range and will be indicated by a green LED. A significantly lower score means that the block being analyzed is badly under-performing and the component it lubricates is likely at risk for premature wear and/or damage. The D.P.S.S. Detector can include a display or can communicate with a mobile communication device and use the display on the mobile communications device. The image in FIG. 10 shows the display of a D.P.S.S. Detector showing an ‘at-risk’ scenario.

The second line of the LCD display indicates that the Analyzer block, in this instance, is cycling at 103.52 seconds, but should be cycling at 76.50 seconds. The third line of the display indicates that 1.74 Pints Per Day (PPD) is reaching the injection point, but 2.35 PPD was expected from the divider block being analyzed. This results in a block output performance score of 73.90%, as presented on the fourth line of the display. A score in the 70 percentile range results in the illumination of the lower amber “Under-Lube” LED. A score below 70% would illuminate one of the red “Under-Lube” LED's. An illumination of any of the amber or red LEDs should command immediate attention, as significant under-lubrication is occurring, and the component lubricated by that injection point is at risk, possibly high risk.

### Operation

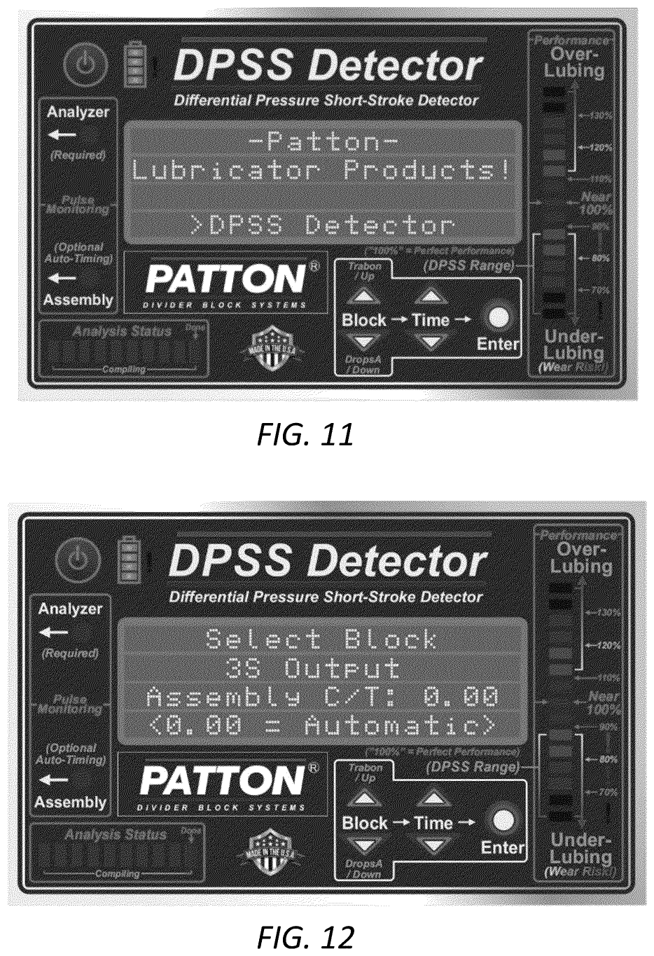

Once the Analyzer block is inserted inline, with fittings tightened well, its Bullet proximity switch should be plugged into the “Analyzer” input of the D.P.S.S. Detector. At that point, power can be applied to the D.P.S.S. Detector. FIG. 11 shows a startup screen after power is applied to the DPSS. After a few a brief pause, it will move on to the settings screen as shown in FIG. 12.

This settings screen prompts the user to set the block value of the divider block supplying the injection point being analyzed. This is selected using the “Block” up/down buttons. The user sets it to the correct block value and version, “S” or “T”. The screen also prompts the user to set the cycle time of the assembly that hosts the divider block being analyzed. There are two methods for setting the cycle time, manual and automatic. Before pressing enter, the user must manually enter the divider block assembly cycle time if the user does not have a temporary proximity switch installed on the divider block assembly to supply pulses to the “Assembly” input of the D.P.S.S. Detector for automatic mode processing.

Manual mode requires manual timing of the divider block assembly, either with a stopwatch or gathering displayed timing from the panel or a device such as a ProFlo. That displayed cycle time is only applicable if it is the cycle time of that specific divider block assembly. An average of at least 3 timed cycles is recommended. Once that time is entered in the D.P.S.S. Detector, it's the locked-in cycle time that it will use to calculate the “Expected” figures. If the assembly speeds up or slows down during the analysis, the D.P.S.S. Detector will not adjust for those fluctuations. The manual cycle is entered using the “Time” up/down buttons. The first five presses of either button will change the time by tenths of a second, then it will begin jumping by half second increments. If a cycle time of “12.7” seconds was needed, the user would navigate to 13.00 seconds with the up button, then 3 presses of the down button.

“Automatic” mode analyzes and averages pulses from a secondary and optional proximity switch temporarily installed on the divider block assembly. It is the most accurate way to do the analysis. If the divider block assembly cycle time fluctuates at all, the D.P.S.S. Detector will adjust for those fluctuations, as it does its math and scoring. It also removes any human error potentially introduced while timing the divider block assembly. To enter automatic mode, simply leave the screen cycle time at “0.00”. However, if the cycle time is left at “0.00”, a proximity switch must be plugged into the “Assembly” input, or no performance scoring can take place.

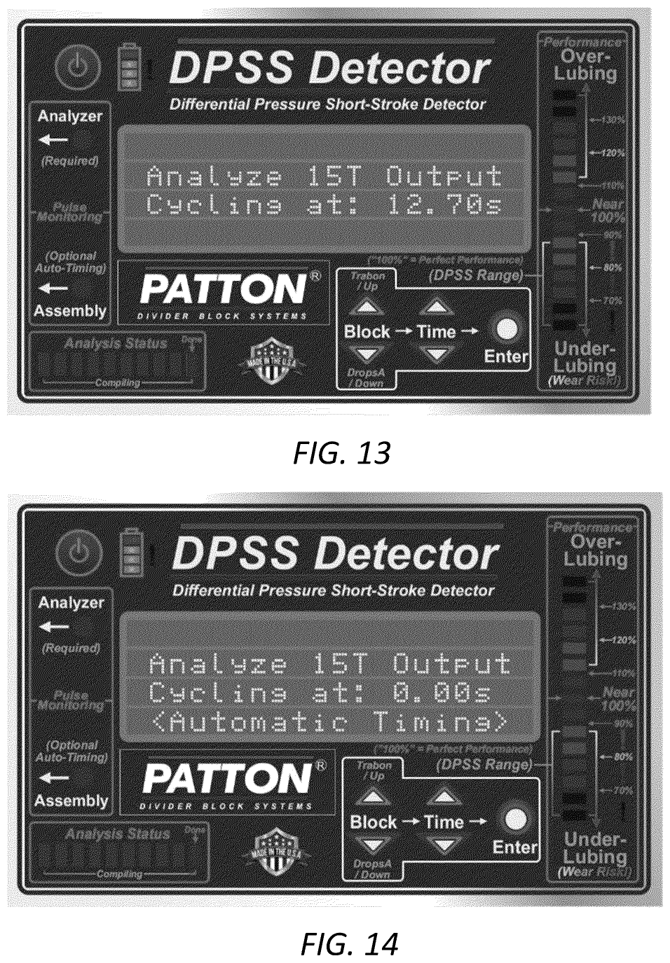

Once the user has chosen automatic mode or manually set the cycle time of the divider block assembly, press the “Enter” button. This will lock in the block value and the cycle time mode for the D.P.S.S. Detector to present the correct math and scoring. After entering a manual cycle time, the screen shown in FIG. 13 is displayed.

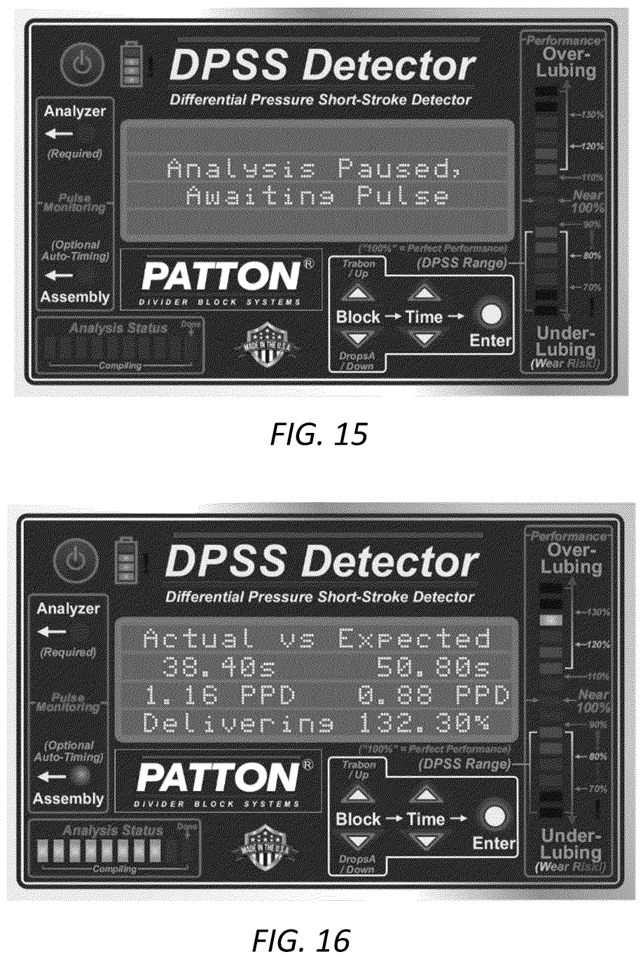

If the user left the cycle time at “0.00” and chose automatic mode, with the proximity switch temporarily installed on the divider block assembly, the screen shown in FIG. 14 will be displayed. After briefly displaying the user's selections, the screen will display a message indicating that it is awaiting a pulse as shown in FIG. 15.

It will continue to display that until it receives the first pulse from the Analyzer block proximity switch. Once a pulse is received, it will then display the analysis data and scoring. The user will see the “Analyzer” LED illuminate any time the D.P.S.S. Detector detects a pulse from the Analyzer block proximity switch.

At first, none of the presented “Actual” or scoring will be accurate. For accuracy, the D.P.S.S. Detector averages 5 timed cycles. Until it has 5 true cycle times to average, the data displayed will be highly inaccurate, as some of the 5 timing fields in its running log that it averages will be at the default of 0.00 seconds. This skews the average and scoring until all 5 fields are populated with a true cycle time greater than “0.00”.

Additionally, the D.P.S.S. Detector pauses between each measured cycle and only times every other cycle. That means that it will require 10 pulses before the scoring is accurate. If the user manually locked in a cycle time during setup, the “Expected” figures will be immediately accurate and will not change. If, on the other hand, the user chose automatic mode, the “Assembly” input will also require 10 pulses for an accurate average to present the “Expected” figures. Both the “Actual” and “Expected” figures will average simultaneously, but it will take a few minutes for accurate scoring. If the final “Expected” cycle time is, for example, 50.8 seconds, the user would need to wait about 8.47 minutes for accurate scoring. Simply divide the “Expected” time by 6 for an estimate of how many minutes it may take for an accurate average and proper scoring. However, if D.P.S.S. is significantly affecting the block's piston, it will take longer than ‘expected/6’, since the Analyzer cycle time will be noticeably slower than “Expected”. The user can track the progress with the “Analysis Status” LED array. FIG. 16 shows a snapshot of the changing results as the analysis progresses.

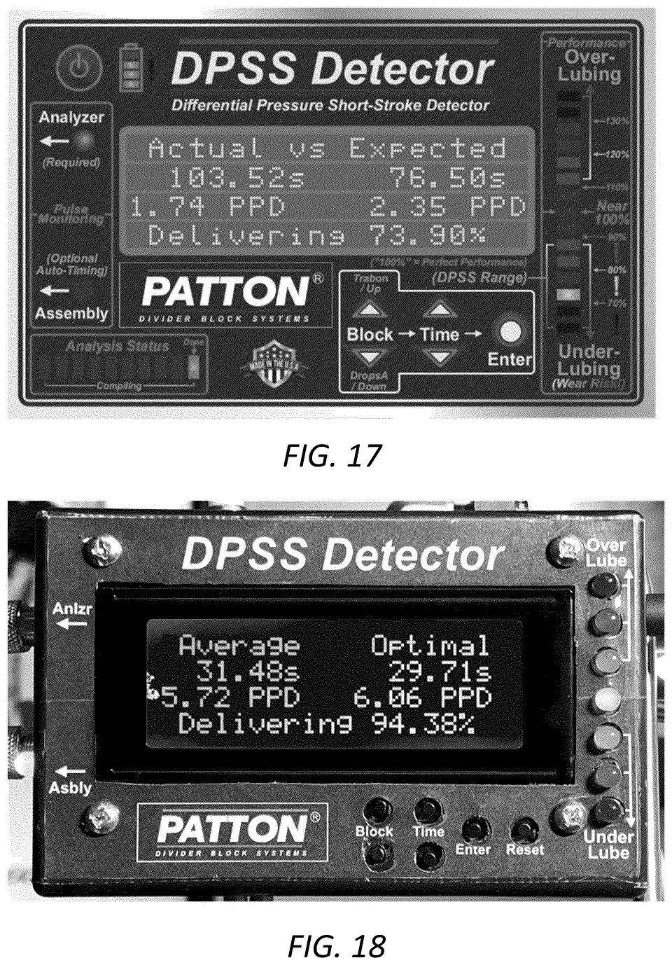

Once the green “Done” LED is illuminated and the numbers don't change significantly, with subsequent Analyzer pulses, the user is seeing accurate scoring. It will fluctuate slightly as it continues to run and more pulses are timed, but the user will have reliable scoring any time after 10 pulses are read. Scoring for an under-performing block after 10 pulses is shown in FIG. 17.

If the screen is pulsating, it is currently timing a cycle. If it is steady, it's between timed cycles. If the user saw the displayed data shown above with a steady screen, the very next pulse would update the “Actual” and scoring features. The user can continue to watch it update at every newly timed cycle, or the user can document what the user see displayed and disconnect the D.P.S.S. Detector. The user can then remove the Analyzer assembly and move to another injection point for inspection.

The most dramatic results are typically found while analyzing the highest-pressure injection points. However, old and bypassing divider blocks can dramatically affect how the assembly's hydraulic circuit responds to differential pressures. Bypassing blocks can cause highly unpredictable results. If the user is analyzing the highest-pressure injection point and seeing optimal scoring, be sure to analyze the remaining injection points, as it's highly likely that others will be scoring poorly.

If the D.P.S.S. detector indicates that adequate lubricant is not being provided at all injection points, the lubricant can be adjusted as described in Applicant's U.S. patent application Ser. No. 18/298,347 for a “Divider Block System and Balancing Valve for Divider Block System.” U.S. patent application Ser. No. 18/298,347 describes systems for measuring the pressure that the lubricant is being injected against and balancing the pressures so that the outputs at the inject points are approximately the same.

The image shown in FIG. 18 shows the screen of the D.P.S.S. Detector when the lubrication system is producing acceptable results. The analyzer is indicating that pulses occur on the average of every 31.48 seconds, corresponding to delivering 5.72 pints per day, while ideally pulses should occur every 29.71 seconds, corresponding to 6.06 PPD.

### Components

### D.P.S.S. Detector

FIG. 5 shows a schematic of a D.P.S.S. detector. The D.P.S.S. Detector includes a processor and a memory for storing data and computer instructions. The D.P.S.S. Detector optionally includes a Bluetooth communications port for accepting input and displaying output on a mobile communication device, such as a cell phone or a tablet, as well as for accepting input from flow analyzers and pressure transducers. The D.P.S.S. Detector optionally includes a touch screen that can accept input and display results to a user. The processor can be, for example, a simple and inexpensive Raspberry Pi.

### Analyzer Block

An analyzer block measures the flow of lubricant. A sensor for measuring fluid flow is described in U.S. Pat. No. 6,850,849, issued Feb. 1, 2005, to the present applicant. To measure fluid flow at the insertion point, a preferred fluid flow sensor entails a dispensing valve having a single-input and a single output. The single output dispensing valve operates in a manner similar to that of a conventional divider block, but the dispensing valve dispenses fluid at a single outlet. Thus, a known amount of lubricant is output for each cycle of the pistons and, by sensing piston cycles as described above, the amount of lubricant dispensed can be readily determined. This single-input single output-divider valve is a positive displacement valve. This valve is suitable for measuring at relatively high pressures very small to extremely small quantities, such as a few cubic inches per day in one embodiment, about 14.0 cubic inches in another embodiment and up to about 10 gallons per day in yet another embodiment. Prior art fluid flow measuring devices were either not suitable for accurately measuring flows in this flow range and pressure or were of complex, geared construction too expensive for use in such applications.

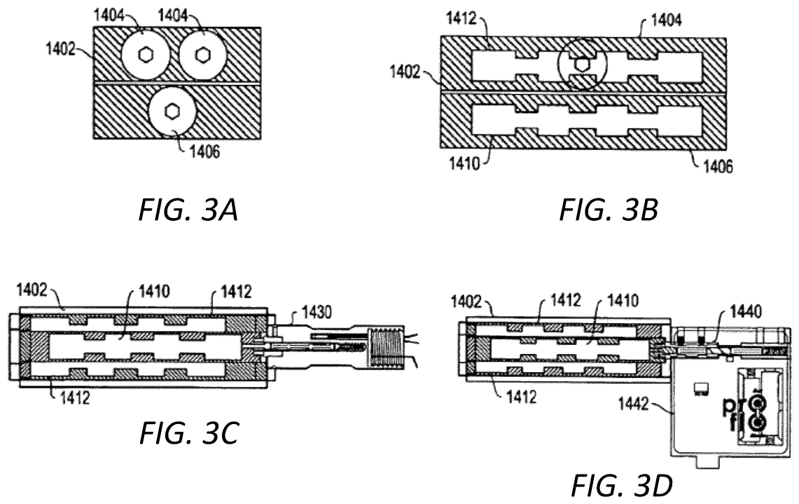

FIGS. 3A-3D shows a single input, single output dispensing valve. Although having a single output, such a dispensing valve can also be referred to generally as a type of divider block. FIG. 3A shows an end view of a dispensing valve 1402 having two cylinders 1404 positioned above a third cylinder 1406. FIG. 3B shows the interior of dispensing valve 1402. FIG. 3B shows a lower piston 1410 in cylinder 1406 and one of upper pistons 1412 in one of the two upper cylinders 1404. Upper pistons 1412 move together. Fluid enters through one of the upper cylinders 1404, moves to a bottom cylinder 1406, and then out of dispensing valve 1402 through an upper cylinder 1404. Skilled persons can readily design pistons and a hydraulic path suitable for various applications. FIG. 3C shows a cross section of single input, single output dispensing valve 1402 with an attached fluid flow sensor 1430 having electrical connections for conveying cycle signals to a remote fluid flow monitor. (Dispensing valve 1402 is shown rotated in FIGS. 3C and 3D so that the lower piston 1412 is shown facing the viewer, and upper pistons 1412 are partially hidden.) The FIG. 3D shows dispensing valve 1402 attached to a fluid flow monitor 1440 that is internal to a fluid flow monitor 1442.

### Proximity Switch

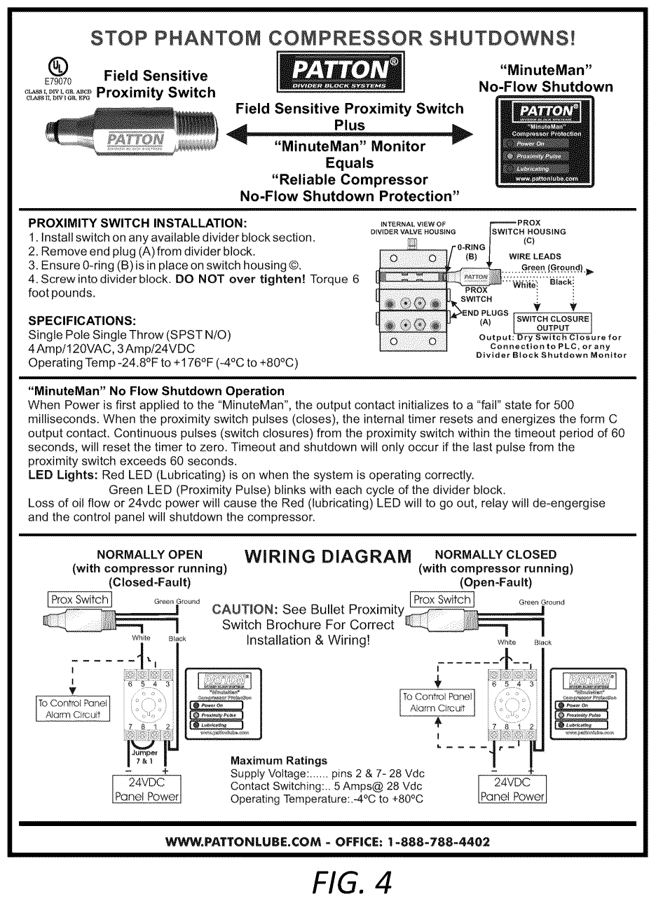

The strokes of a divider block piston can be counted by using a proximity switch that detects when the piston approaches the end of its stroke. Applicant's U.S. Pat. No. 8,561,477, issued Oct. 22, 2013, describes a proximity switch. FIG. 4 shows an example of a commercially available proximity switch. Another proximity switch is described in Applicant's U.S. Design Pat. 947135 for a “Field Sensitive Proximity Switch Housing.”

### ProFlow

The ProFlow monitors the cycles of outputs of a divider block and are described, for example, in U.S. Pat. No. 5,835,372 to Roys et al.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines. manufacture, compositions of matter, means, methods, or steps.

We claim as follows:

1. A system for detecting whether the quantity of lubricant being application to a compressor is correct, comprising:
a lubricant pump;
a multiple output divider block for providing lubricant to multiple injection points on a compressor system;
multiple single input/single output divider block analyzers, each multiple single input/single output divider block analyzers in line with an injection point;
an analyzer having an input and a display and comprising:
a processor;
a memory storing computer instruction to be executed by the processor to:
accept input of the amount of lubricant per cycle of a single input/single output divider block;
accept signals from a proximity switch indicating cycles of the single input/single output divider block;
calculate an actual amount of lubricant being delivered in a specific time period;
compare an actual amount of lubricant being delivered in a specific time period to a prespecified expected amount of lubricant being delivered; and
indicate on the display whether or not the actual amount of lubricant delivered in the specified time period is within a specified range.

2. The system of claim 1 in which memory storing computer instruction to be executed by the processor includes a computer instruction to form a ratio of the actual lube flow to the expected lube flow and in which indicating on the display whether or not the actual amount of lubricant delivered in the specified time period is within a specified range comprises indicating whether or not the ratio is within a specified range.

3. The system of claim 1 in which the analyzer includes a touch screen for entering data and a display for displaying data.

4. The system of claim 1 in which the analyzer includes a Bluetooth transmitter and receiver for accepting input and displaying output on a mobile computing device.

5. A method of detecting whether or not a divider block lubrication system is providing a prescribed amount of lubrication to a natural gas compressor, comprising:
providing a fluid flow analyzer in line with an injection point on the natural gas compressor, the fluid flow analyzer ejecting a known amount of fluid for each cycle of the fluid flow analyzer;
providing a processing system;
inputting into the processing system the amount of lubricant ejected during each cycle;
determining the frequency or period of cycles of the fluid flow analyzer;
calculating by the processing system the actual amount of lubricant being injected at the injection point by multiplying the amount of lubricant ejected during each cycle by the number of cycles in a prescribed time period;
comparing by the processing system the actual amount of lubricant being injected at the injection point with a predetermined expected value of lubricant being injected at the injection point;
if the actual amount of lubricant being injected at the injection point differs from the predetermined expected value by a predetermined threshold, alerting an operator to the discrepancy;
investigating and correcting the reason for the discrepancy, thereby reducing premature wear on the compressor system.

6. The method of claim 5 in which determining the frequency or period of cycles of the fluid flow analyzer comprises receiving by the cycle signals from the fluid flow analyzer and determining the number of cycles in a time period to determine the frequency of the fluid flow analyzer.

7. The method of claim 5 in which determining the frequency or period of cycles of the fluid flow analyzer comprises manually timing cycles of fluid flow analyzer and entering the cycle timing into the processing system.

8. The method of claim 5 in which inputting into the processing system the amount of lubricant ejected during each cycle determining the number of cycles in a time period comprises inputting using a mobile computing device.

9. The method of claim 8 in which alerting an operator to the discrepancy comprises alerting the operator via a mobile computing device.

10. The method of claim 5 in which the processing device includes a screen and in which alerting an operator to the discrepancy comprises alerting the operator via a message on the screen of the processing device.

11. The method of claim 5 in which inputting into the processing system the amount of lubricant ejected during each cycle determining the number of cycles in a time period comprises inputting using a touch screen on the processing system.
